(19) United States
(12) Patent Application Publication
(10) Pub. No.: US 2009/0119441 A1
(43) Pub. Date: May 7, 2009

(54) Heterogeneous Parallel Bus Switch

(75) Inventor: Matthew J. West, Salem, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 12/203,595

(22) Filed: Sep. 3, 2008

Related U.S. Application Data
(60) Provisional application No. 61/002,061, filed on Nov. 6, 2007.

(51) Int. Cl. G06F 13/00

(52) U.S. Cl. 710/316

(57) ABSTRACT

A parallel bus switch has an input stage configured to convert a bus signal from a first bus having a first configuration to a second configuration, an internal standard bus configured to receive the bus signal in the second configuration and transport the bus signal to an output stage. The output stage is configured to convert the bus signal from the second configuration to a third configuration used by a data recipient and transmit the bus signal to a second bus corresponding to the data recipient.

### RELATED APPLICATION

The present application is related to and claims the priority under 35 U.S.C. §119(e) of U.S. Provisional Patent Application No. 61/002,061, entitled “Heterogeneous Parallel Bus Switch,” filed Nov. 6, 2007, which previous application is hereby incorporated by reference in its entirety.

### BACKGROUND

In electronic and optical systems, a bus is a subsystem that transfers data, power, and/or clock signals between electronic or optical components. A parallel bus involves several individual conductors or data channels that carry different signals simultaneously, such as those composing a single digital word, between components.

Buses may transfer signals among a myriad of different components. For example, a given component may use a bus signal from one source at one instant and the bus signal from another source at another instant, where both of the bus signals are received through the same input port at that component.

A bus switch is often used to selectively route bus signals received at input ports of the switch to one or more components connected to output ports of the switch. Traditional parallel bus switch architecture assumes that all signals in the bus have predefined purposes or adhere to a standard bus protocol. For example, the particular arrangement or placement of a signal among the multiple data channels of the parallel bus is indicative of the nature or purpose of that signal. Such bus standards facilitate communication between equivalent or “hot-swappable” data producers and data recipients that adhere to the same standard.

However, in some situations, factors such as board layout considerations and design communication may result in data producers or recipients having parallel buses with signals that do not align. Thus, a traditional parallel bus switch may not seamlessly and effectively transfer signals among such components.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of an illustrative embodiment of a parallel bus switch, according to principles described herein.

FIG. 2 is a diagram of an illustrative embodiment of a parallel bus switch, according to principles described herein.

FIG. 3 is a block diagram of an input stage of an illustrative embodiment of a heterogeneous parallel bus switch, according to principles described herein.

FIG. 4 is a block diagram of an output stage of an illustrative embodiment of a heterogeneous parallel bus switch, according to principles described herein.

FIG. 5 is a block diagram of another embodiment of an output stage of an illustrative embodiment of a heterogeneous parallel bus switch, according to principles described herein.

FIG. 6 is a block diagram of an input stage of an illustrative embodiment of a heterogeneous parallel bus switch, according to principles described herein.

FIG. 7 is a block diagram of an output stage of an illustrative embodiment of a heterogeneous parallel bus switch, according to principles described herein.

FIG. 8 is a flowchart of an illustrative embodiment of a method of routing a parallel bus signal, according to principles described herein.

FIG. 9 is a flowchart of another illustrative embodiment of a method of routing a parallel bus signal, according to principles described herein.

Throughout the drawings, identical reference numbers designate similar, but not necessarily identical, elements.

### DETAILED DESCRIPTION

As mentioned above, buses are used to transfer data, power, and/or clock signals in electronic and optical systems. Often bus switches are used to selectively route bus signals between system components.

However, traditional parallel bus switch architecture assumes that all signals in the bus have predefined purposes according to a bus standard or protocol to facilitate the communication between equivalent or “hot-swappable” data producers and recipients. In some situations, factors such as board layout considerations and poor design communication may result in data producers and recipients having parallel buses whose signals do not align or do not adhere to the same standard or protocol. Traditional parallel bus switches may not seamlessly and effectively transfer signals among such components.

Some prior solutions require that all data producers and recipients adhere to a strict bus standard or protocol. This is potentially disadvantageous when an existing board does not adhere to those standards or a printed circuit board layout does not provide a way to route the signals to the appropriate location without sufficient signal integrity loss or additional layers on the board.

Other prior solutions require a field programmable gate array (FPGA) be specifically reprogrammed to support a particular configuration of data producers and/or recipients. While this approach may provide a sufficient interface between a data producer, a data recipient and a bus switch, the process of managing FPGA profiles leads to more configuration management hardware for the FPGA, which in some cases incurs significant additional costs. Furthermore, for large FPGA designs, the workflow for creating new FPGA profiles can require a substantial amount of time to complete.

It may be desirable, therefore, to provide a heterogeneous parallel bus switch that can seamlessly interface with data producers and recipients having different bus structures.

Accordingly, the present specification discloses a heterogeneous parallel bus switch having an input bus interface, an output bus interface and an internal standard bus. The heterogeneous parallel bus switch has a first switching module configured to switch individual signals from the input bus interface to predetermined locations on the internal standard bus. The internal standard bus is in communication with a second switching module that is configured to switch the individual signals in the standard bus to the configuration used by the output bus interface.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

In general, a component outputting a signal is referred to as a data source, and a component receiving and using such a signal is referred to as a data recipient. A particular component may function as both a data source and recipient. The principles disclosed herein will now be discussed with respect to illustrative systems and methods.

### Illustrative Systems

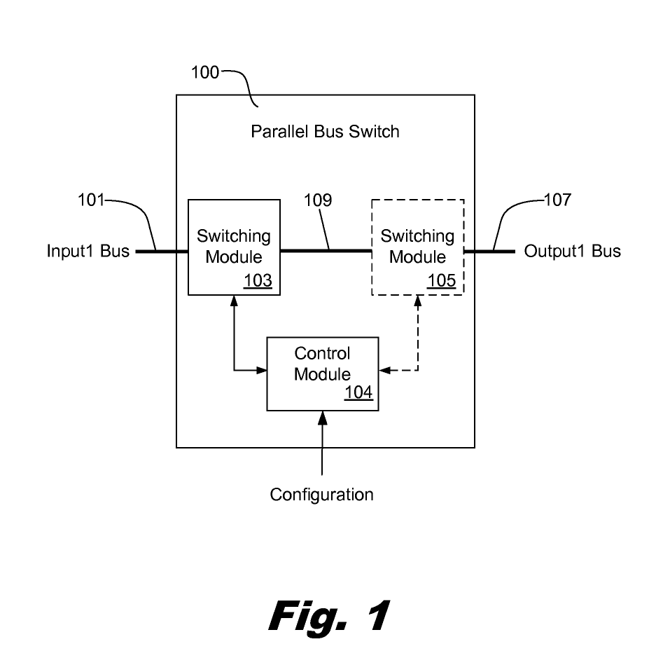

Referring now to FIG. 1, a block diagram of an illustrative heterogeneous bus switch (100) is shown. The bus switch (100) has an input bus interface (101) and an output bus interface (107). The input bus interface (101) is configured to receive a bus signal (Input1) of a first format from a data source and the output bus interface (107) is configured to output a bus signal (Output1) of a second format to a data recipient.

In some embodiments, both buses (Input1, Output1) include the same number of data channels, with each data channel in the input bus (Input1) having a corresponding data channel in the output bus (Output1). However, the relative positions of corresponding data channels within the input bus (Input1) and the output bus (Output1) may not align, as described above.

Consequently, the parallel bus switch (100) includes a first switching module (103) that interfaces with an internal standard bus (109). The switching module (103), in various embodiments, may have electronic logic configured to selectively interconnect individual signals from the input bus (Input1) to corresponding conductors on the internal standard bus (109). Consequently, the signals or data channels from the input bus interface (101) in a first arrangement or format can be rearranged to a second arrangement or format that may be needed by a data recipient. The rearranged bus signal is then output through the output bus interface (107) to the output bus (Output1).

A control module (104) may be used to control the operations of the switching module (103). The control module (104) may receive configuration settings from an exterior source, such as a user interface or another electronic component. The control module (104) may then convert the configuration data into a format used by the switching module (103) and transmit the data to the switching module (103) so as to program the switching module (103) to make a particular transformation in the arrangement of the data channels on the bus. In some embodiments, the switching module (103) and control module (104) may be components in a state machine in which the switching module (103) is configured according to certain detected conditions.

Thus, because the format of the buses (Input1, Output1) used with the parallel bus switch may vary in different designs, the switching module (103) is configurable or programmable to account for such variations. In some embodiments, the switching module (103) may be dynamically configured to adapt to changes in an electronic system that occur throughout system operations.

In some embodiments, a second switching module (105) may also be used. As above, the second switching module (105) may have electronic logic configured to selectively interconnect the individual signals on the internal standard bus (109) to corresponding data channels or conductors on the output bus (Output1).

In such embodiments, the first switching module (103) may switch the format of the bus signal from the input interface (101) to a standard format used by the internal bus (109). If needed, the second switching module (105) then switches the format of the bus signal from that standard format to a format used by a data recipient receiving the bus signal from the output interface (107). The input bus signal (Input1) may therefore enter the parallel bus switch (100) through the input interface (101), be switched to an internal bus (109) by the switching module (103), and be switched to a configuration of the output bus (Output1) by the second switching module (105). The bus data may then be transferred to the output bus (Output1) by the output interface (107), where it may be received by a data recipient.

The switching modules (103, 105) may include, for example, predefined multiplexing circuitry or networks of multiplexing circuitry. In various embodiments, the switching modules (103, 105) may include programmable application specific integrated circuits (ASICs), field programmable gate arrays (FPGAs), controllable switch networks, and the like.

The control module (104) may control both the first and second switching modules (103, 105). Thus, the switching modules (103, 105) may respond to electronic signals received from the control module (104) to adjust the configuration of the interconnections between the buses (Input1, Output1) and the internal standard bus (109).

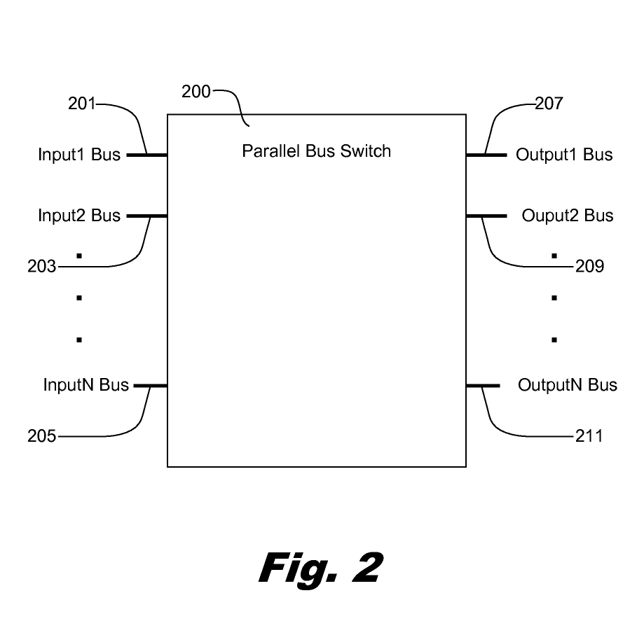

Referring now to FIG. 2, another illustrative heterogeneous parallel bus switch (200) is shown. The bus switch (200) of the present example includes a plurality of input bus interfaces (201, 203, 205) configured to receive data from a plurality of buses (Input1, Input2, InputN) corresponding to individual data sources. The illustrative bus switch (200) also includes a plurality of output bus interfaces (207, 209, 211) configured to provide data to a plurality of buses (Output1, Output2, OutputN) corresponding to individual data recipients.

As shown, an illustrative parallel bus switch (200) according to the principles described above may be used to not only provide bus signals received from a data recipient in one configuration to a data recipient in another configuration, but also to selectively switch signals received at one input bus interface (201, 203, 205) to one or more output bus interfaces (207, 209, 211).

Thus, the bus signals (Input1, Input2, InputN) may be selectively routed through the parallel bus switch (200) and provided to the intended destination output interface(s) in the desired format. A controller may dynamically change the routing and bus format configurations in response to user input or detected conditions.

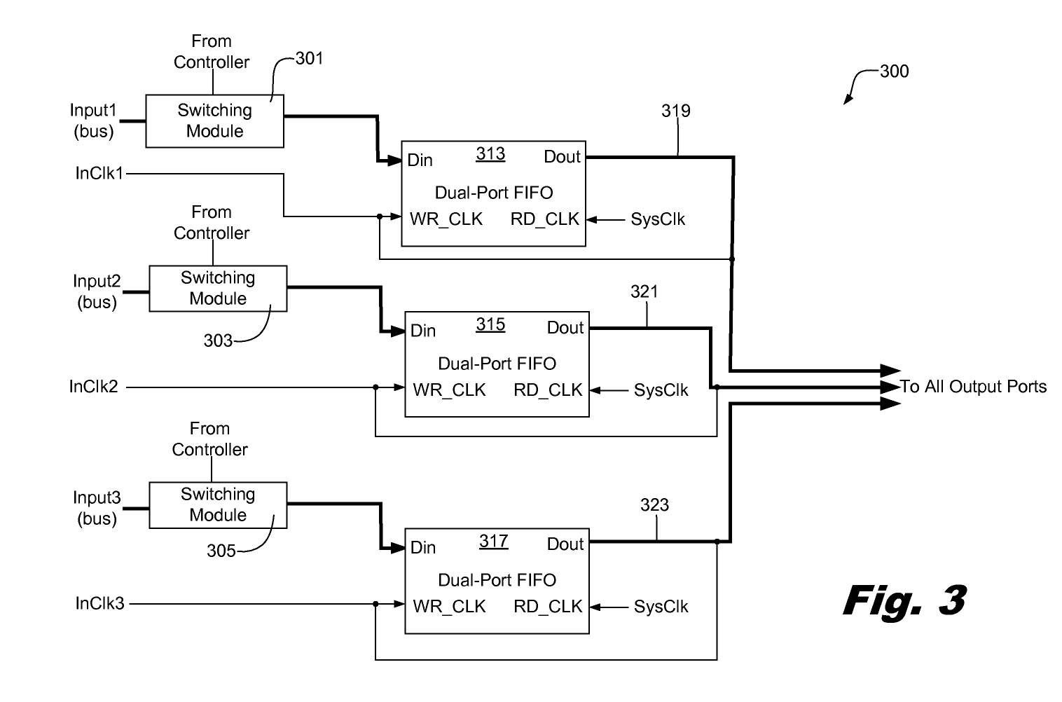

Referring now to FIG. 3, a block diagram of an input stage (300) of an illustrative heterogeneous parallel bus switch is shown. The input stage (300) includes a plurality of input buses (Input1, Input2, Input3) that are received into the input stage (300) and enter switching modules (301, 303, 305). The switching modules (301, 303, 305) are configured by a controller and interconnect individual signals from the input buses (Input1, Input2, Input3) with corresponding data channels in an internal standard configuration. Digital clock signals (InClk1, InClk2, InClk3) corresponding to each bus (Input1, Input2, Input3) are also received into the input stage (300). In some embodiments, the clock signals are considered part of the bus signals (InClk1, InClk2, InClk3), and are routed through the switching modules (301, 303, 305).

The controller described in the present and subsequent examples of the bus switch architecture is configured to provide input signals to various components in the bus switch. These input signals affect the configuration of the components and the operation of the bus switch. However, some of these input signals may require modification, whether by dynamic modification during switch operations or according to the varying needs of different systems that employ bus switches according to the principles described herein.

In some embodiments, the controller may be a plurality of registers storing values to be used as the input signals. The contents of these registers may be altered by system data or from a user configuration. Additionally, in some embodiments the controller may include an electronic processing element, such as a microcontroller or other logical data circuit. It should be understood, however, that many suitable types of controllers are available and known in the art.

The signals in the internal standard configuration are then received into corresponding dual-port, first in first out (FIFO) electronic queues (313, 315, 317). The FIFO queues (313, 315, 317) are configured to store the data signals present at an input (Din) at a rate determined by a write clock signal (WR_CLK). The input clock signals (InClk1, InClk2, InClk3) corresponding to the buses (Input1, Input2, Input3) are routed to the FIFO queues (313, 315, 317) and used as write clock signals (WR_CLK) to sample the data from the switching modules (301, 303, 305).

By using the input clock signals (InClk1, InClk2, InClk3) corresponding to the input buses (Input1, Input2, Input3), the digital data present on the input buses (Input1, Input2, Input3) can be sampled at the correct moments in time to ensure that accurate representations of the sequential data are stored in the dual-port FIFO queues (313, 315, 317).

The dual-port FIFO queues (313, 315, 317) have output ports (Dout) configured to provide the next bits in a sequence of digital data stored in the queues (313, 315, 317) when indicated by a read clock signal (RD_CLK). In the present example, an internal system clock signal (SysClk) is used for the read clock signal (RD_CLK) at each of the dual-port FlFOs (313, 315, 317). The internal system clock signal (SysClk) is generated by a local oscillator, such as a crystal oscillator, and each of dual-port FIFO queues (313, 315, 317) receives the same system clock signal for read functions.

As each of the input buses (Input1, Input2, Input3) of the present embodiment has its own corresponding clock signal (InClk1, InClk2, InClk3, respectively), the data from the input buses may be provided at different rates. For this reason, among others, the data are cued into the dual-port FIFO queues (313, 315, 317). By using a standard system clock signal (SysClk) for the read clock signals (RD_CLK) in the dual-port FIFO queues (313, 315, 317), asynchronously queued input data may be synchronously transferred from the output ports (Dout) of the dual-port FIFO queues (313, 315, 317) to standard internal buses (319, 321, 323).

To preserve the integrity of the data, the system clock signal (SysClk) must operate at a faster frequency than the fastest of the input clock signals (InClk1, InClk2, InClk3). Thus, the output ports (Dout) of the dual-port FIFO queues (313, 315, 317) are sampled and transferred to the internal standard buses (319, 321, 323) more frequently than the data signals on the output ports (Dout) are transitioning through the data received from the input buses (Input1, Input2, Input3).

The input clock signals (InClk1, InClk2, InClk3) are routed with the internal standard buses (319, 321, 323) to all output ports in the heterogeneous parallel bus switch.

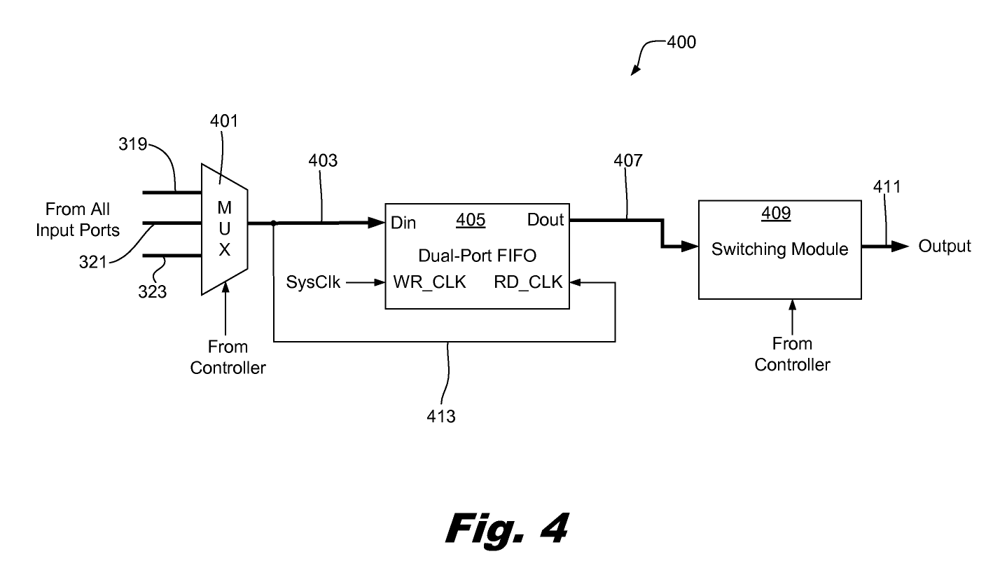

Referring now to FIG. 4, an illustrative output stage (400) is shown of a heterogeneous parallel bus switch having the input stage (300, FIG. 3) described above. The illustrative output stage (400) shown may correspond to only one of many similar output ports in the bus switch.

As described previously, the internal standard buses (319, 321, 323) are routed to each of the output ports. In the present output stage (400), the internal standard buses (319, 321, 323) are received by a multiplexer (401). The multiplexer (401) is configured to use a control signal from the controller to selectively route one of the internal standard bus signals (319, 321, 323) through an output signal (403) to the input (Din) of a dual-port FIFO queue (405). The data on the internal standard buses (319, 321, 323) is sampled at the input (Din) of the dual-port FIFO queue (405) and stored in the FIFO queue (405) using the same internal clock signal (SysClk) that was used to place the data on the internal standard buses (319, 321, 323).

The embedded input clock signal (413) is extrapolated from the multiplexer output signal (403) and used as the read clock signal (RD_CLK) in the dual-port FIFO queue (405) to read the data at the output (Dout) of the dual-port FIFO queue (405) after at least M samples have been loaded into the dual-port FIFO where M is a number determined by the fastest clock frequency and its associated jitter. The data read at the output (Dout) of the FIFO queue (405) is routed to a switching module (409) using connection (407). Complementary to the switching modules (301, 303, 305) of the input stage (300, FIG. 3), the switching module (409) in the output stage (400) is configured by the controller to interconnect individual signals from the internal bus signal received from connection (407) to corresponding conductors in an output bus (411). The input clock signal (413) extrapolated from the standard bus multiplexer output (403) and connected to the read clock node (RD_CLK) of the FIFO queue (405) is a component in the final output of the output bus (411) to the data recipient.

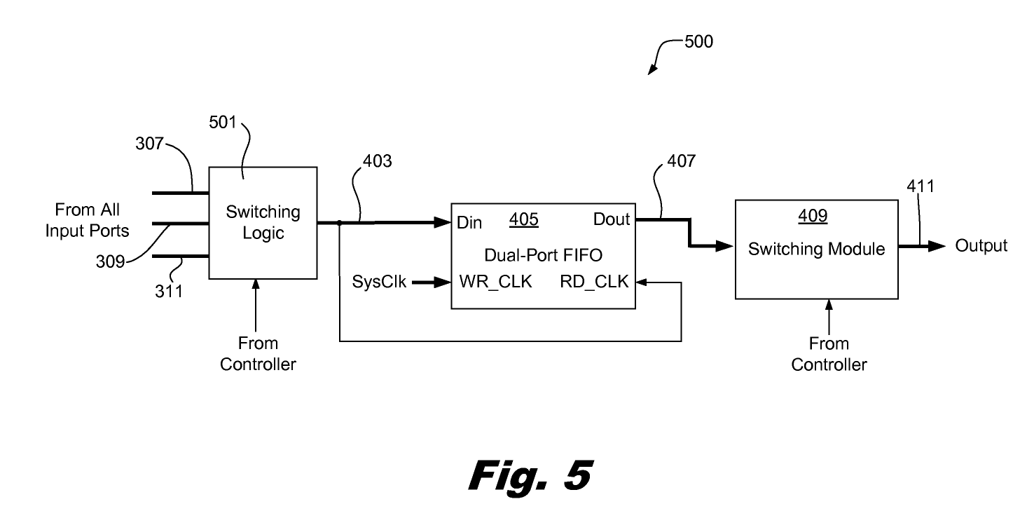

Referring now to FIG. 5, an alternative illustrative output stage (500) using the previously described the input stage (300, FIG. 3) is shown. In place of a multiplexer (401, FIG. 1), the present output stage (500) utilizes switching logic (501), such as a field programmable gate array (FPGA) or a configurable transistor network.

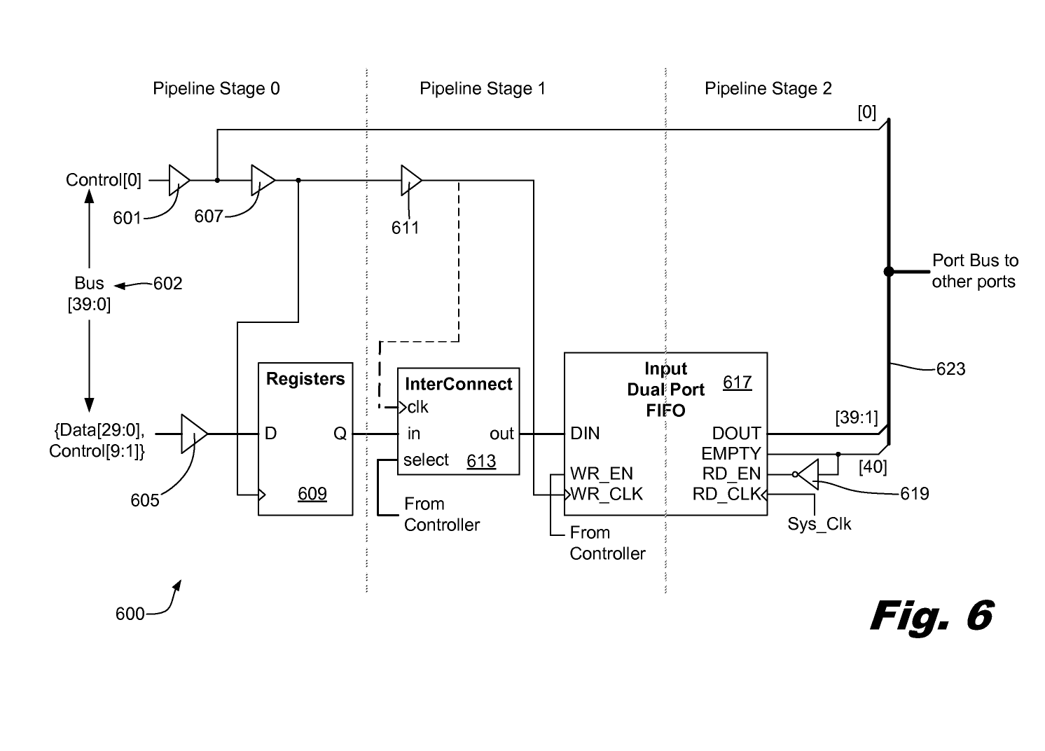

Referring now to FIG. 6, another illustrative input stage (600) of a heterogeneous parallel bus switch is shown. A 40-bit input bus (602) includes 10 control bits (Control[9:0]) and 30 data bits (Data[29:0]). The illustrative input stage (600) includes three pipeline stages: Pipeline Stage 0, Pipeline Stage 1, and Pipeline Stage 2. In the present example, Control[0] corresponds to a clock signal component of the input bus (602).

In Pipeline Stage 0 of the input stage (600), Control[0] serves as a clock signal as the rest of the input bus (602) is sampled at an input port (D) of an electronic registers module (609). Buffers (601, 605, 607, 611) are used to condition signals in preparation for the signal transmission to various modules, thus ensuring correct timing throughout the various pipeline stages. In some embodiments, the buffers may be omitted depending on the implementation technology.

In Pipeline Stage 1, the data in the registers (609) are transferred from an output (Q) of the registers module (609) to the input (in) of an interconnect module (613) when enabled by a controller. The interconnect module (613) converts the parallel data received from the input bus (602) into a standard format used by the system. The interconnect module (613) optionally uses the input clock (WR_CLK), if additional intermediate pipeline stages are needed for timing purposes. The data from the input bus (602) are transferred from an output port (out) of the interconnect (613) to the input port (DIN) of a dual-port FIFO queue (617) using connection (615). When an enable bit (WR_EN) of the FIFO queue (617) is set high by the controller, the data from the input bus are sampled at DIN using Control[0] as the input clock (WR_CLK) for the dual-port FIFO queue (617).

In Pipeline Stage 2, an internal system clock (Sys_Clk) is used to read the data from the dual-port FIFO queue (617) at an output port (DOUT) and transfer the data to bits [39:1] of an internal port bus (623). The original input bus clock signal (Control[0]) is also routed to the internal port bus (623) as bit [0]. When the dual-port FIFO queue (617) has no remaining bus data, an “empty” node (EMPTY) is set high. The status of this “empty” node (EMPTY) is also routed to all output ports via the internal port bus (623). Additionally, in this example, a read enable node (RD_EN) on the dual-port FIFO queue (617) is constantly held high by a digital inverter (619) that is connected to the “empty” node (EMPTY), until the FIFO queue (617) is empty. Once the FIFO queue (617) is empty, the “empty” node (EMPTY) is set high, thereby causing that the read enable node (RD_EN) be set low. The internal port bus (623) is routed to each output port of the heterogeneous parallel bus switch.

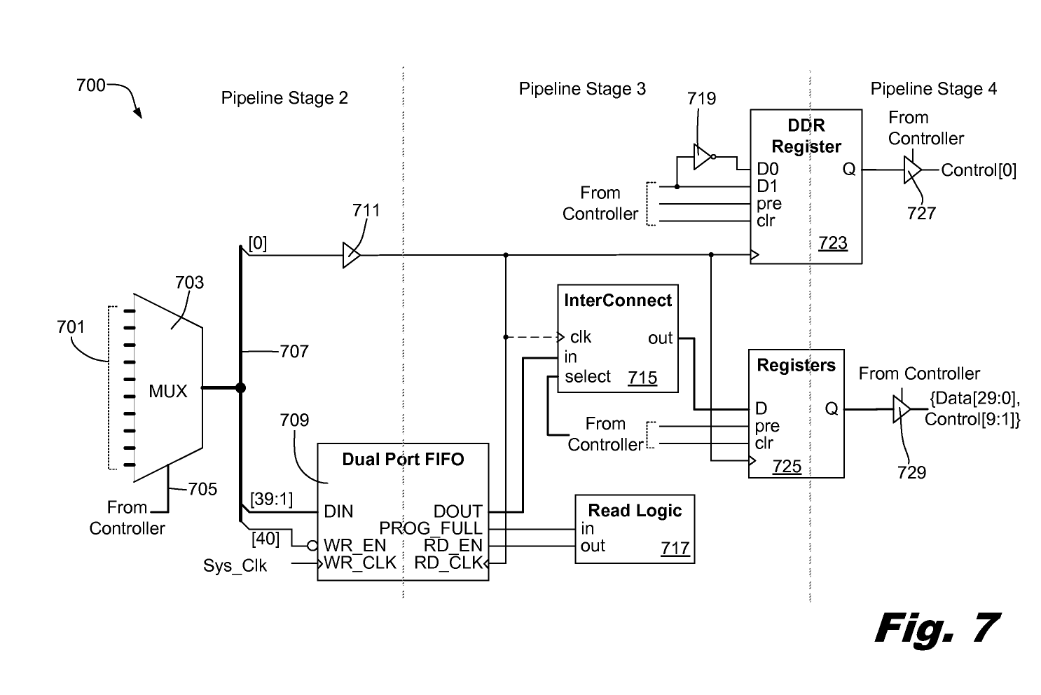

Referring now to FIG. 7, an illustrative output stage (700) of the heterogeneous parallel bus switch having the input stage (600, FIG. 6) described previously. The output stage (700) continues the pipeline, having components of Pipeline Stage 2, Pipeline Stage 3, and Pipeline Stage 4.

During Pipeline Stage 2 in the output phase, a plurality of internal port buses (701), received from each of the input stages of the bus switch, are received into a multiplexer (703). A control signal (705) from the controller selectively routes bits [40:1] of the selected internal port bus (707) to another dual-port FIFO queue (709). Bits [39:1] are sampled into the dual-port FIFO queue (709) using the same system clock signal (Sys_Clk) as was used with the input stage (600, FIG. 6). Bit [40] of the selected internal port bus (707) carries the status of the “empty” node (EMPTY) of the dual-port FIFO queue (617, FIG. 6) used in the input stage (600, FIG. 6) of the selected internal port bus (707), and the inverse of bit [40] is connected to the write enable node (WR_EN) of the dual-port FIFO queue (709) of the output stage (700). Thus, the dual-port FIFO (709) will only store sample and store data until the FIFO queue (617, FIG. 6) used in the input stage (600, FIG. 6) is empty.

During Pipeline Stage 3, the bus data is transferred from the output node (DOUT) to an interconnect module (715) using the clock signal in bit[0] (i.e. Control[0]) of the selected internal port bus (707). This signal (bit [0]) passes through a buffer (711) prior to being received at the read clock node (RD_CLK) of the FIFO queue (709) to compensate for delays from the FIFO queue (709) sampling and storing the data. A programmable full (PROG_FULL) node may be used in conjunction with read logic (717) to determine when a read enable (RD_EN) node in the FIFO queue (709) should be enabled to begin reading data from the FIFO queue (709). Once the data has started to flow out of the FIFO queue (709), the queue (709) will not be empty unless an error in the input stream or a controller induced reset occurs. This is true since the original input stream clock is used as the output stream clock, thus compensating for any jitter or frequency shifting, thereby allowing for continuous valid data on the output stream.

The interconnect module (715) is configured to convert the parallel data received from the output node (DOUT) of the FIFO queue (709) into a format used by a data recipient that is to receive the output bus from the parallel bus switch. The interconnect module (715) optionally uses the read clock (RD_CLK), if additional intermediate pipeline stages are needed for timing purposes. The output of the interconnect module (715) is connected to the input nodes (D) of parallel electronic registers (725), where the parallel bus data are stored. The registers (725) may have preset (pre) and clear (clr) nodes that are set by the controller thus enabling static values on the output buffers (729). These registers (725) use the clock signal from bit[0] to sample and store the data, and to output the data through a buffer (729).

Additionally, the clock signal from bit[0] is used to generate a new clock signal using a double data rate register (723), consistent with principles well-known in the art. The double data rate register (723) has two input nodes (D0, D1). In the present example, D1 is set by the controller, along with preset and clear nodes. D0 receives the opposite of D1, using a digital inverter (719). The double data rate register (723) is configured to alternately output at Q the values of D0, and D1. As one of the input nodes (D0, D1) is configured to maintain a digital high voltage (1) and the other is configured to maintain a digital low voltage (0), the output at Q is an alternating sequence of 1's and 0's. Furthermore, since the double data rate register (723) is configured to switch the source of its output at both rising and falling clock edges received from bit[0], the clock signal from bit[0] is regenerated at the output (Q) of the double data rate register (723). By changing the value on D1, the output at Q is phase shifted by 180 degrees, thus making the output clock to data relationship compatible with various types of synchronous clocking methodologies used by the data recipient.

The outputs from the double data rate register (723) and the other registers (725) are combined and output through buffers (727, 729) to a data recipient as a 40 bit bus having 30 data bits and 10 control bits. The 40 bit bus output to the data recipient is in the bus configuration used by the data recipient.

### Illustrative Methods

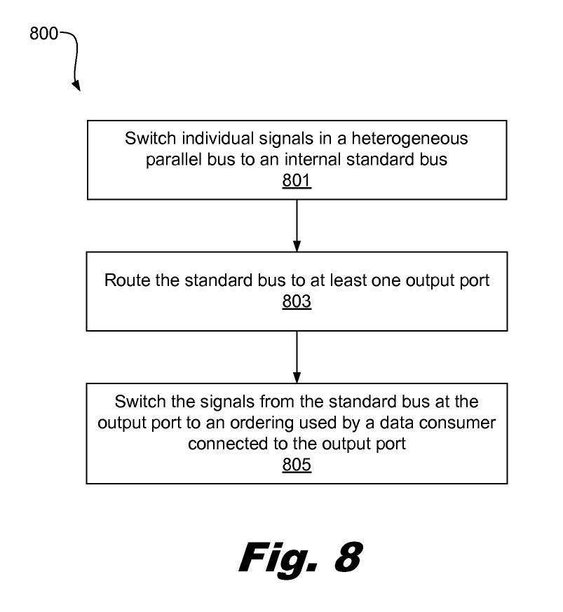

Referring now to FIG. 8, a flowchart diagram of an illustrative method (800) of switching a parallel bus signal is shown. The method (800) includes switching (step 801) individual signals in a heterogeneous parallel bus to an internal standard bus. The standard bus is then routed (step 803) to at least one output port. In some embodiments, the standard bus is routed to a plurality of output ports, and a multiplexer is used at each output port to select a desired standard bus. The method (800) also includes the step of switching (step 805) the signals from the standard bus at the output port to an ordering used by a data recipient connected to the output port.

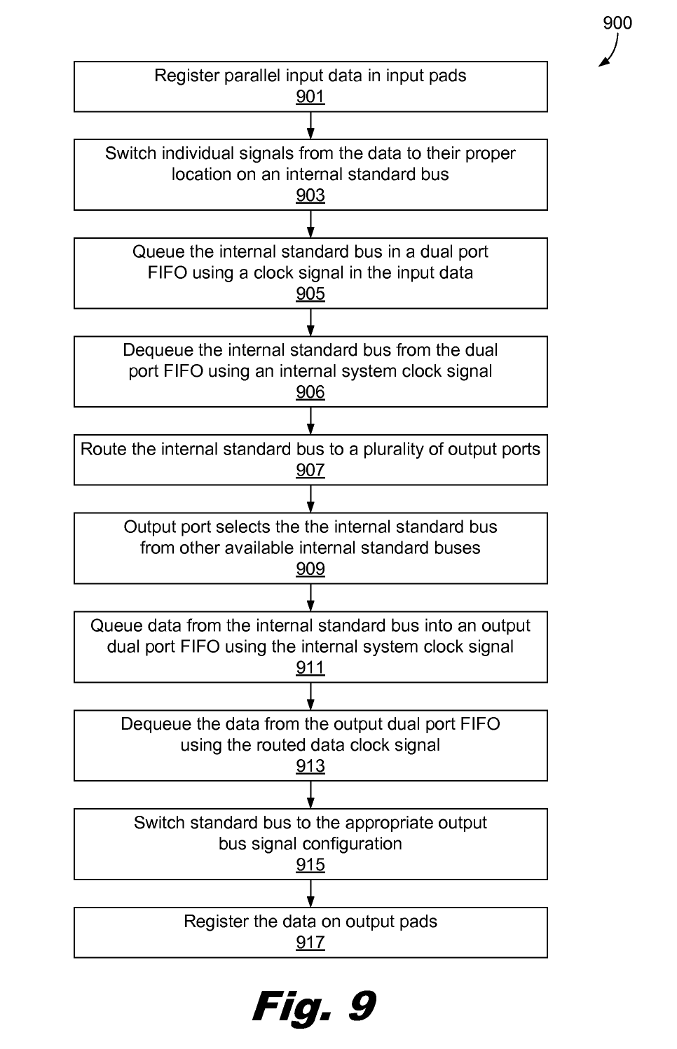

Referring now to FIG. 9, a flowchart diagram of another illustrative method (900) of switching a parallel bus signal is shown. The method (900) includes the steps of registering (step 901) parallel input data in input pads and switching (step 903) individual signals from the data to their proper location on an internal standard bus. The proper location on the internal standard bus may vary in different embodiments, however standard bus formats and configurations within individual systems implementing the present method should not vary.

The internal standard bus is then queued (step 905) in a dual-port first in first out (FIFO) register. The data may be queued in the FIFO register using an associated clock signal from the input data. The internal standard bus is then dequeued (step 906) from the FIFO register using an internal system clock signal. The internal standard bus is then routed (907) to a plurality of output ports. An individual output port selects (step 909) the data from other available internal standard buses. This may be done using a multiplexer.

Data is then queued (step 911) from the selected internal standard bus into an output dual-port FIFO using the internal system clock signal. The data is dequeued (step 913) from the output FIFO using the associated clock signal from the input data. The internal standard bus is then switched (step 915) to the appropriate output bus signal configuration.

The appropriate output bus signal configuration may be different from the input bus signal configuration, and may vary in specific implementations. The data is then registered (step 917) on output pads, where the data may then be received by an associated data recipient.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A parallel bus switch, comprising:
an input stage configured to convert a bus signal from a first bus having a first configuration to a second configuration;
an internal standard bus configured to receive said bus signal in said second configuration and transport said bus signal to an output stage;
wherein said output stage is configured to convert said bus signal from said second configuration to a third configuration used by a data recipient and transmit said bus signal to a second bus corresponding to said data recipient.

2. The parallel bus switch of claim 1, wherein said output stage further comprises an output interface configured to electronically connect said output stage to said second bus.

3. The parallel bus switch of claim 1, wherein said input stage comprises digital logic components configured to interconnect individual bit lines in said first configuration from said first bus with corresponding bit lines in said second configuration of said internal standard bus.

4. The parallel bus switch of claim 1, wherein said output stage comprises digital logic components configured to interconnect individual bit lines in said second configuration from said internal standard with corresponding bit lines in said third configuration of said second bus.

5. The parallel bus switch of claim 1, wherein said input stage and said output stage are in communication with a control module designed to configure components in said input and output stages according to said first, second, and third configurations.

6. The parallel bus switch of claim 1, wherein said input stage comprises a plurality of input interfaces configured to convert a plurality of input bus signals to said second configuration, and a plurality of internal standard buses configured to receive said plurality of bus signals from said input stage.

7. The parallel bus switch of claim 5, wherein said output stage comprises a plurality of output interfaces, wherein each of said output interfaces is configured to:
select one of said plurality of internal standard buses;
convert said bus signal from said selected internal standard bus to said third configuration; and
transmit said bus signal to a bus corresponding to said data recipient.

8. A parallel bus switch, comprising:
a plurality of input stage switching modules, wherein each of said switching modules is in communication with one of a plurality of input buses and configured to convert a an input signal from said input bus to a standard configuration;
a plurality of input stage FIFO queues, wherein an input of each of said queues is in communication with an output of one of said plurality of switching modules;
a plurality of internal standard buses, wherein each of said internal standard buses is in communication with an output of one of said plurality of FIFO queues;
an output port having a multiplexer configured to selectively route one of said internal standard buses to an input of an output stage FIFO queue and an output stage switching module in communication with an output of said output stage FIFO queue, wherein said output stage switching module is configured to convert data from said output stage FIFO queue to a configuration used by a data recipient.

9. The parallel bus switch of claim 8, wherein said input stage switching modules comprise a plurality of digital logic components configured to interconnect individual bit lines in said input buses with corresponding bit lines in said standard configuration.

10. The parallel bus switch of claim 8, wherein said output stage switching module comprises a plurality of digital logic components configured to interconnect individual bit lines in said selected internal standard bus with corresponding bit lines in said configuration used by said data recipient.

11. The parallel bus switch of claim 8, wherein said input stage switching modules and said output stage switching module are in communication with a control module designed to adapt said switching modules according to said input bus configuration, said standard configuration, and said configuration used by said data recipient.

12. The parallel bus switch of claim 11, wherein said control module comprises a plurality of digital registers configured to store digital values configured for use as control signals in digital logic components of said switching modules.

13. The parallel bus switch of claim 8, wherein each of said input signals from said input buses comprises an input clock signal.

14. The parallel bus switch of claim 12, wherein each of said input clock signals is electrically routed to a write clock input in each of said corresponding input stage FIFO queues and a read clock input in each of said corresponding output stage FIFO queues.

15. The parallel bus switch of claim 8, further comprising an oscillator configured to provide an internal system clock signal at a read clock input of said input stage FIFO queue and a write clock input of said output stage FIFO queue.

16. A method of switching a parallel bus signal, said method comprising:
switching individual signals in said bus signal to corresponding individual signals in an internal standard bus;
routing said internal standard bus to at least one output port; and
switching said individual signals in said internal standard bus at said output port to a configuration used by a data recipient connected to said output port.

17. The method of claim 16, further comprising queuing said internal standard bus in a dual-port FIFO using a clock signal from said bus signal prior to routing said internal standard bus to said output port.

18. The method of claim 17, further comprising dequeuing said internal standard bus in said dual-port FIFO using an internal clock signal prior to routing said internal standard bus to said output port.

19. The method of claim 16, further comprising queuing said internal standard bus in an output stage dual-port FIFO using said internal clock signal.

20. The method of claim 19, further comprising said internal standard bus from said output stage dual-port FIFO using said clock signal from said bus signal.
